(19) United States
(12) Patent Application Publication
(10) Pub. No.: US 2003/0231573 A1
(43) Pub. Date: Dec. 18, 2003

(54) Optical pickup device

(76) Inventors: Kozo Matsumoto, Kanagawa (JP); Kazuhiko Kimura, Kanagawa (JP); Hideyoshi Horimai, Shizuoka (JP)

Correspondence Address: Mark Montague, Esq., Cowan, Liebowitz & Latman, P.C., 1133 Avenue of the Americas, New York, NY, 10036, US

(21) Appl. No.: 10/463,660

(22) Filed: Jun. 17, 2003

(30) Foreign Application Priority Data
Jun. 18, 2002 (JP) P2002-176556

(51) Int. Cl. G11B 7/135

(52) U.S. Cl. 369/112.29; 369/44.12

(57) ABSTRACT

In an optical pickup device in which the response of track follow-up control is improved, a polarizing beam splitter (PBS) combines information light and reference light, and the combined light is made incident on a recording disk via an optical rotary plate divided into two parts, a tracking galvano-mirror, relay lenses, a follow-up galvano-mirror and an objective lens. The tracking galvano-mirror can scan the combined light in a radial direction of the recording disk, and the follow-up galvano-mirror can scan the combined light in a track direction of the recording disk. The objective lens can be moved in opposite directions toward and away from the recording disk by a direct driving type of actuator.

### BACKGROUND OF THE INVENTION

1. Field of the Invention

The present invention relates to an optical pickup for use in a hologram recording system or a hologram recording/reproducing system.

2. Description of the Related Art

A system for recording information on a disk-shaped recording medium by using holograms is drawing much attention. This method records information on a recording medium as an interference pattern, and can be expected to realize high-density recording. For example, there are JP-A-2001-256654, JP-A-2001-273650, JP-A-2002-83431 and JP-A2002-123949.

In general, information is recorded on a plurality of concentric tracks or on a single helical track of the disk-shaped recording medium. In the case where information is to be recorded or reproduced on the disk-shaped recording medium, it is necessary to control focus and tracking.

In hologram recording, it is further necessary to secure recording power at a predetermined level or higher. In the case of the disk-shaped recording medium, information is recorded while the disk-shaped recording medium is being continuously rotated. Since the writing speed of information is proportional to the rotating speed of the disk-shaped recording medium, means for giving sufficient exposure energy in a short time is desired. Of course, an optical pickup and a driving system therefore need to be lightweight and compact and to be inexpensively manufacturable. Small mass serves to improve tracking performance.

For example, as means for increasing recording power without increasing the output power of a laser light source, it is possible to consider the idea of causing information light and reference light to follow up the movement of a track of the disk-shaped recording medium in a direction tangential to the track along the rotating direction of the disk-shaped recording medium, thereby reducing the relative speed difference between the disk-shaped recording medium and the information light and the reference light. The operation and the control of causing laser light to follow up the movement of a track in a direction tangential to the track will be hereinafter referred to as “track follow-up”.

In this track follow-up, a pickup itself is made to follow up the rotation of the disk-shaped recording medium so that a laser illumination position is fixed at the same position for a predetermined time. However, if the pickup itself is moved, there occurs the disadvantage that the response of servo control is inferior.

### OBJECT AND SUMMARY OF THE INVENTION

The invention has been made to ameliorate the above-described disadvantage, and an object of the invention is to provide an optical pickup device capable of exhibiting a good response to focusing, tracking and track follow-up.

An optical pickup device according to the invention includes: a main optical system having a laser light source; an electrically driven, first beam deflector for deflecting laser light outputted from the main optical system; an electrically driven, second beam deflector for deflecting laser light deflected by the first beam deflector; an objective lens for focusing output light of the second beam deflector on a disk-shaped recording medium; and an objective lens driving device for driving the objective lens in opposite directions toward and away from the disk-shaped recording medium. One of the first and second beam deflectors deflects the laser beam to cause the laser beam to move on a recording layer of the disk-shaped recording medium in a radial direction of the disk-shaped recording medium, and the other of the first and second beam deflectors deflects the laser beam to cause the laser beam to move on the recording layer of the disk-shaped recording medium in a circumferential direction of the disk-shaped recording medium.

According to this construction, since track follow-up, tracking and focusing are driven by separate driving means, it is possible to select driving means each having a response suitable for a respective one of track follow-up, tracking and focusing. Accordingly, it is possible to easily obtain preferable characteristics for each of track follow-up, tracking and focusing.

The main optical system is made of, for example, an interference optical system.

Preferably, each of the first and second beam deflectors is made of a galvano-mirror. Accordingly, it is possible to obtain a sufficiently high-speed response.

An optical pickup device according to the invention further includes a relay optical system disposed between the first beam deflector and the second beam deflector and constructed to transfer the output light of the first beam deflector to the second beam deflector. Accordingly, it is possible to increase the degree of freedom of arrangement of the first and second beam deflectors.

Preferably, the first beam deflector is disposed at an object-side principal point of the relay optical system and the second beam deflector is disposed at an image-side principal point of the relay optical system. Accordingly, the laser beam enters the second beam deflector at the same position irrespective of the deflection of the laser beam by the first beam deflector.

Preferably, the main optical system includes an image sensor for converting reproducing light reproduced from the disk-shaped recording medium, into an electrical signal.

Various other objects, advantages and features of the present invention will become readily apparent to those of ordinary skill in the art, and the novel features will be particularly pointed out in the appended claims.

### BRIEF DESCRIPTION OF THE DRAWINGS

The following detailed description, given by way of example and not intended to limit the present invention solely thereto, will best be appreciated in conjunction with the accompanying drawings, wherein like reference numerals denote like elements and parts, in which:

FIG. 1 is a perspective view showing an embodiment of the invention;

FIG. 2 is a plan view showing an optical system of this embodiment;

FIG. 3 is a schematic block diagram showing the construction of this embodiment;

FIG. 4 is a timing chart showing the control operation of a galvano-mirror 54 during recording;

FIG. 5 is a perspective view showing either of a galvano-mirror 48 and the galvano-mirror 54;

FIG. 6 is an exploded perspective view of the galvano-mirror 48 or 54;

FIG. 7 is a cross-sectional view taken along line A-A of FIG. 5;

FIG. 8 is a cross-sectional view taken along line B-B of FIG. 5;

FIG. 9 is an explanatory view showing the optical functions of the galvano-mirror 54 and an objective lens 56; and

FIG. 10 is an explanatory view showing the optical functions of the galvano-mirror 48, relay lenses 50 and 52, the galvano-mirror 54 and the objective lens 56.

### DETAILED DESCRIPTION OF PREFERRED EMBODIMENTS

A preferred embodiment of the invention will be described below in detail with reference to the accompanying drawings.

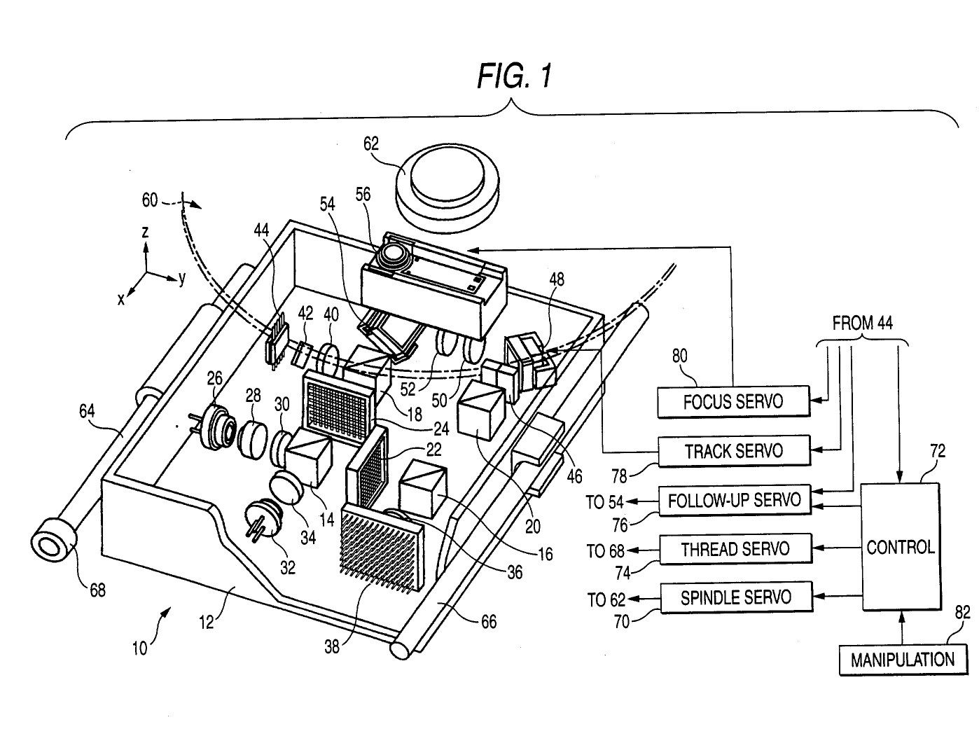

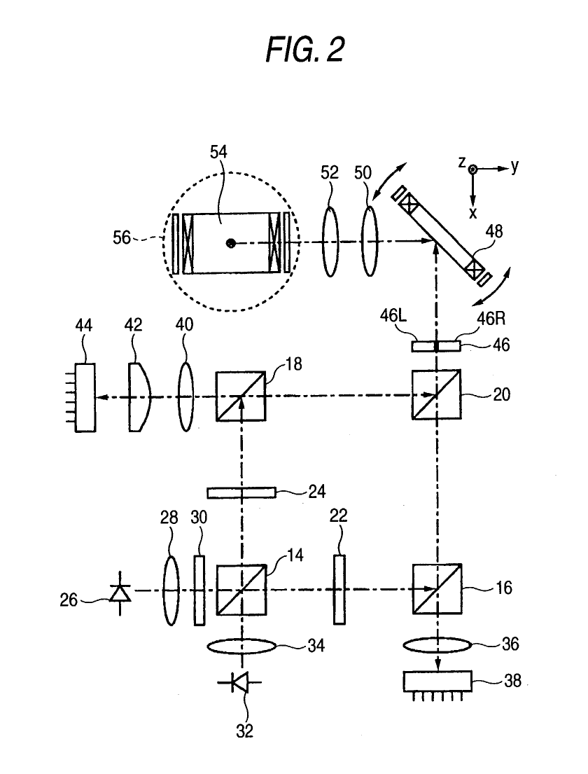

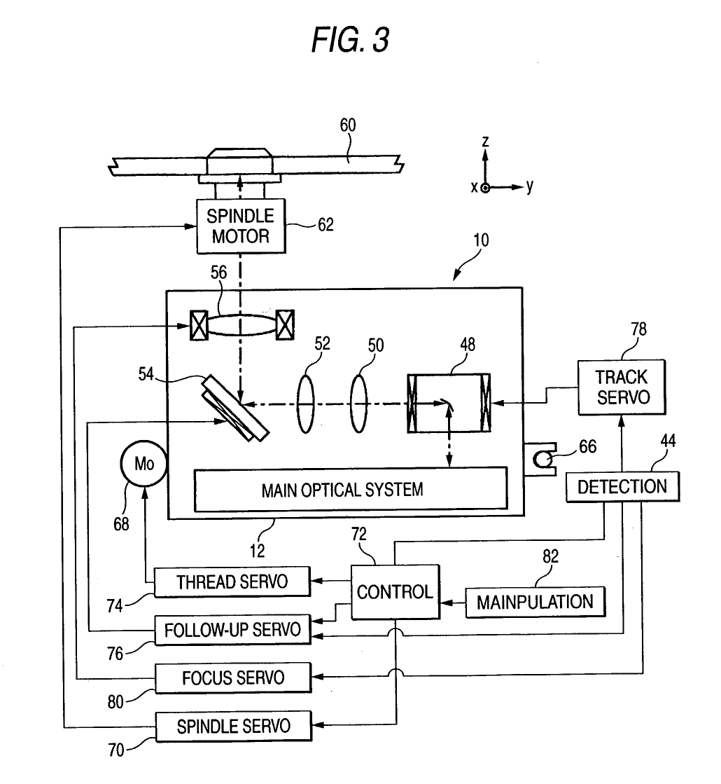

FIG. 1 is a perspective view showing the embodiment of the invention, FIG. 2 is a plan view showing the essential parts of an optical-pickup optical system of the embodiment, and FIG. 3 is a schematic block diagram showing the construction of the embodiment.

An optical pickup 10 of the embodiment is accommodated in a case 12. A Mach-Zehnder interference optical system for recording and reproducing a hologram is disposed in the case 12. The Mach-Zehnder interference optical system includes a polarizing beam splitter (PBS) 14, half mirrors 16 and 18, and a polarizing beam splitter 20. Namely, one optical path is formed to lead from the PBS 14 to the PBS 20 via the half mirror 16, while the other optical path is formed to lead from the PBS 14 to the PBS 20 via the half mirror 18. A spatial optical modulator 22 is disposed on the former optical path, while a phase modulator 24 is disposed on the latter optical path. As will be described later in detail, information light for hologram recording propagates along the former optical path, while reference light for hologram recording and reference light for hologram reproduction propagate along the latter optical path.

Each of the spatial light modulator 22 and the phase modulator 24 is made of an element, such as a liquid crystal panel, which has a plurality of two-dimensionally distributed pixels and enables the transmission/non-transmission and the transmission phase of each of the pixels to be controlled from the outside. Each of the spatial light modulator 22 and the phase modulator 24 is controlled in various modes which differ for recording, servo control and reproduction.

During servo control, the spatial light modulator 22 is controlled so that all the pixels assume an optically non-transmitting state, while the phase modulator 24 is controlled so that the pixels are brought into phase with one another.

During recording, the spatial light modulator 22 is controlled so that each of the pixels assumes an optically transmitting or non-transmitting state according to whether information to be recorded is “0” or “1”. The phase modulator 24 is controlled to assume a predetermined modulation pattern in which the phase of light transmitted through each of the pixels assumes 0 degrees or 90 degrees with respect to a predetermined reference phase. The predetermined modulation pattern may be arbitrarily selected by a user, or may also be automatically determined according to predetermined conditions.

During reproduction, the spatial light modulator 22 is controlled so that all the pixels are brought into the optically non-transmitting state. The phase modulator 24 is controlled so that the phase of light transmitted through each of the pixels assumes a predetermined modulation pattern corresponding to the modulation pattern assumed during recording.

In terms of operation, it is apparent that the phase modulator 24 may also be disposed on the optical path which leads from the PBS 14 to the PBS 20 via the half mirror 16 and the spatial light modulator 22 may also be disposed on the optical path which leads from the PBS 14 to the PBS 20 via the half mirror 18.

Servo-control laser light and hologram-recording reproducing laser light enter the PBS 14. Namely, a servo-control laser 26, a collimator lens 28 and a quarter wavelength plate 30 are disposed on the side of one entrance surface of the PBS 14. A hologram recording/reproducing laser 32 and a collimator lens 34 are disposed on the side of another entrance surface of the PBS 14.

A condenser lens 36 and an image sensor 38 for receiving hologram-recording reproducing light are disposed on the outward side of the half mirror 16. A condenser lens 40, a cylindrical lens 42 and a light receiver 44 for receiving (reflected light of) servo-control laser light are disposed on the outward side of the half mirror 18. Each of galvano-mirrors 48 and 54 functions as a beam deflector or a light deflector.

An optical rotary plate 46, a tracking galvano-mirror 48, relay lenses 50 and 52, a follow-up galvano-mirror 54 for causing a laser beam to follow up a track on a recording disk 60 in a direction tangential to the track during recording, and an objective lens 56 are disposed between the recording disk 60 and the interference optical system including the PBS's 14 and 20 and the half mirrors 16 and 18.

he optical rotary plate 46 has a form divided into a right optical rotary plate 46R and a left optical rotary plate 46L. The right optical rotary plate 46R rotates entering polarized light in the clockwise direction by 45 degrees, while the left optical rotary plate 46L rotates entering polarized light in the counterclockwise direction by 45 degrees.

The tracking galvano-mirror 48 is used for moving the laser beam at high speed in the radial direction of the recording disk 60 and positioning the laser beam on a desired track.

The follow-up galvano-mirror 54 is used for moving the laser beam along the track of the recording disk 60 in the rotating direction thereof during recording. Accordingly, the rotating speed of the recording disk 60 can be made relatively slow, whereby recording light of far higher power can be applied to the recording disk 60. In the case where the speed at which the laser beam is moved by the follow-up galvano-mirror 54 coincides with the linear velocity of the recording disk 60 on the disk medium surface of the recording disk 60, the recording disk 60 is placed into a state equivalent to the state of being temporarily stopped during recording, whereby it is possible to realize high-power recording with long-time exposure.

Referring to FIGS. 1 and 2, letting the X-Y plane denote a plane parallel to the disk medium surface of the recording disk 60 and the X-axis denote an axis perpendicular to the disk medium surface of the recording disk 60, the tracking galvano-mirror 48 can oscillate about the Z-axis, whereby reflected light can be scanned in the X-axis direction in the X-Y plane. The follow-up galvano-mirror 54 can oscillate about the X-axis, whereby reflected light can be scanned in the Y-axis direction in the X-Y plane.

The objective lens 56 can be moved in opposite directions toward and away from the recording disk 60 by a direct driving type of actuator, thereby controlling focus.

A spindle motor 62 rotates the recording disk 60. The case 12 of the optical pickup 10 can be moved in the X-axis direction, i.e., in the radial direction of the recording disk 60, by guide shafts 64 and 66. Each of the guide shafts 64 and 66 is made of, for example, a lead screw (ball thread). A thread motor 68 causes the guide shaft 66 to rotate about the axis thereof, thereby moving the case 12 in opposite directions along the X-axis.

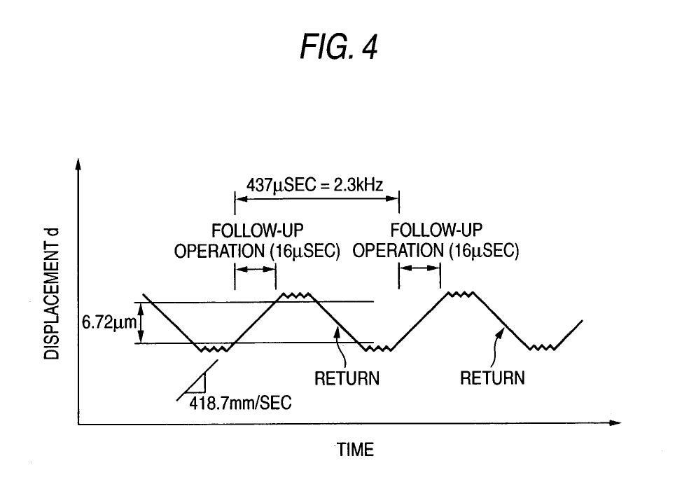

A spindle servo device 70 drives the spindle motor 62 in accordance with a control signal supplied from a control device 72, to control the rotating speed of the recording disk 60 at a predetermined value. A thread servo device 74 rotates the thread motor 68 in a desired rotating direction at a desired speed in accordance with an instruction given by the control device 72. A follow-up servo device 76 oscillates the follow-up galvano-mirror 54 at predetermined timing in accordance with an instruction given by the control device 72 and the output of the light receiver 44. A track servo device 78 oscillates the tracking galvano-mirror 48 at predetermined timing in accordance with the output of the light receiver 44, and positions the laser beam on a specified track. A focus servo device 80 positions the objective lens 56 in the Z-axis direction in accordance with the output of the light receiver 44 so that the focus of the objective lens 56 coincides with the recording layer of the recording disk 60. Incidentally, the timing of oscillation of each of the galvano-mirrors is shown in FIG. 4 which will be described later.

The user can specify an operation mode such as a recording mode or a reproduction mode for the control device 72 through a manipulation device 82 including a manipulation panel and manipulation switches. The manipulation device 82 may also be a separate computer.

In the embodiment, one track of the recording disk 60 is divided into a plurality of areas, and the whole (or only the leading part) of each of the areas serves to activate the track servo device 78 or the focus servo device 80. During recording, the data part of each of the areas serves to activate the follow-up servo device 76.

The propagation path of the output light of the servo-control laser 26 will be described before in brief. As described previously, during servo control, the control device 72 controls the spatial light modulator 22 so that all the pixels thereof assume the optically non-transmitting state, and controls the phase modulator 24 so that the pixels thereof are brought into phase with one another.

The servo-control laser 26 outputs linearly polarized red laser light. The output light of the servo-control laser 26 is collimated into a parallel laser beam by the collimator lens 28 and the parallel laser beam is circularly polarized by the quarter wavelength plate 30, and the obtained circularly polarized light enters the PBS 14. The PBS 14 divides the entering light into two light beams, the one of which is applied to the spatial light modulator 22 and the other of which is applied to the phase modulator 24. The spatial light modulator 22 intercepts the entering light, while the phase modulator 24 outputs the entering light without modification. Accordingly, the output light of the servo-control laser 26 enters the half mirror 18 and is half-reflected to the PBS 20 by the half mirror 18. The PBS 20 supplies the laser light from the half mirror 18 to the optical rotary plate 46. The laser light is already circularly polarized and, therefore, the optical rotary plate 46 does not at all influence servo-control laser light.

The laser light which has entered the optical rotary plate 46 is reflected by the tracking galvano-mirror 48, relayed by the relay lenses 50 and 52, reflected by the follow-up galvano-mirror 54, focused onto the recording disk 60 by the objective lens 56, and reflected by the recording disk 60. The servo-control laser light reflected by the recording disk 60 enters the light receiver 44 via the objective lens 56, the follow-up galvano-mirror 54, the relay lenses 52 and 50, the tracking galvano-mirror 48, the PBS 20, the half mirror 18, the condenser lens 40 and the cylindrical lens 42. The light receiver 44 converts the entering light into an electrical signal, and applies the electrical signal to the control device 72, the follow-up servo device 76, the track servo device 78 and the focus servo device 80.

The propagation path of the output light of the hologram recording/reproducing laser 32 during recording will be described below in brief As described previously, during recording, the control device 72 controls the spatial light modulator 22 so that each of the pixels assumes an optically transmitting or non-transmitting state according to whether information to be recorded has a binary value of “0” or “1”, and also controls the phase modulator 24 so that the phase modulator 24 assumes the predetermined modulation pattern in which the phase of light transmitted through each of the pixels assumes 0 degrees or 90 degrees with respect to the predetermined reference phase.

The hologram recording/reproducing laser 32 outputs linearly polarized green laser light which is inclined by 45 degrees to the plane of polarization of transmitted light (or reflected polarized light) of the polarizing beam splitter 14. The output light of the hologram recording/reproducing laser 32 is collimated into a parallel laser beam by the collimator lens 34, and the parallel laser beam enters the PBS 14. The entering light includes an S-polarized component and a P-polarized component each having an equal light intensity by the PBS 14. The one of the components (for example, the S-polarized component) enters the spatial light modulator 22, while the other (for example, the P-polarized component) enters the phase modulator 24.

The spatial light modulator 22 enables or disables the entering light to be transmitted through each of the pixels in accordance with information to be recorded, whereby information light for carrying the information to be recorded is generated. Half of the information light is transmitted through the half mirror 16, while the other half is reflected by the half mirror 16 and enters the optical rotary plate 46 through the PBS 20.

In the meantime, the phase modulator 24 modulates the phase of the P-polarized component received from the PBS 14, in accordance with a modulation pattern set by the control device 72, whereby reference light for hologram recording is generated. Half of this reference light is transmitted through the half mirror 18, while the other half is reflected by the half mirror 18 and is also reflected by the PBS 20 and enters the optical rotary plate 46.

At the time point when the information light enters the optical rotary plate 46, the information light includes the S-polarized component, while the reference light includes the P-polarized component. The optical rotary plate 46 is divided into the right optical rotary plate 46R which rotates the plane of polarization of entering light in the clockwise direction by 45 degrees, and the left optical rotary plate 46L which rotates the plane of polarization of entering light in the counterclockwise direction by 45 degrees. Accordingly, the information light is separated into two mutually perpendicular polarized components which are rotated by 45 degrees with respect to each other. The reference light is also similar to the information light. The information light transmitted through the right optical rotary plate 46R of the optical rotary plate 46 and the reference light transmitted through the left optical rotary plate 46L of the optical rotary plate 46 include the components polarized in the same direction and are capable of interfering with each other. Similarly, the information light transmitted through the left optical rotary plate 46L and the reference light transmitted through the right optical rotary plate 46R include the components polarized in the same direction and are capable of interfering with each other.

The information light and the reference light which have been transmitted through the optical rotary plate 46 are reflected by the tracking galvano-mirror 48, relayed by the relay lenses 50 and 52, reflected by the follow-up galvano-mirror 54, and focused onto the recording disk 60 by the objective lens 56. In this manner, an interference pattern formed by the information light and the reference light is recorded on the recording disk 60.

During recording on the recording disk 60, the control device 72 controls the follow-up galvano-mirror 54 through the follow-up servo device 76, and moves the spots of the information light and the reference light on the recording disk 60 instantaneously by a short time in the direction tangential to the track of the recording disk 60. Accordingly, the spots of the information light and the reference light can be located at the same position on the recording disk 60 for a longer time, whereby larger light power can be applied to the recording disk 60. In other words, the output power of the hologram recording/reproducing laser 32 can be reduced.

The propagation path of reproducing reference light for reproducing information from the recording disk 60 during reproduction and the propagation path of reproducing information light for carrying reproduced information during reproduction will be described below in brief. As described previously, during reproduction, the control device 72 controls the spatial light modulator 22 so that all the pixels are brought into the optically non-transmitting state, and controls the phase modulator 24 so that the phase of light transmitted through each of the pixels assumes a modulation pattern axisymmetric with respect to the modulation pattern assumed during recording.

Similarly to the case of recording, the hologram recording/reproducing laser 32 outputs linearly polarized green laser light which is inclined by 45 degrees to the plane of polarization of transmitted light (or reflected light) of the polarizing beam splitter 14. The output light of the hologram recording/reproducing laser 32 is collimated into a parallel laser beam by the collimator lens 34, and the parallel laser beam enters the PBS 14. The PBS 14 divides the entering light into an S-polarized component and a P-polarized component each having an equal light intensity, and applies one of the components (for example, the S-polarized component) to the spatial light modulator 22 and the other (for example, the P-polarized component) to the phase modulator 24.

The spatial light modulator 22 disables the transmission of the S-polarized component received from the PBS 14. In the meantime, the phase modulator 24 modulates the phase of the P-polarized component received from the PBS 14, in accordance with the modulation pattern axisymmetric with respect to the modulation pattern assumed during recording, whereby reproducing reference light is generated. Half of the reproducing reference light is transmitted through the half mirror 18, while the other half is reflected by the half mirror 18 and is also reflected by the PBS 20 and enters the optical rotary plate 46.

The optical rotary plate 46 rotates the polarization plane of half of the reproducing reference light received from the PBS 20, in the clockwise direction by 45 degrees, and the polarization plane of the other half in the counter clockwise direction by 45 degrees, thereby generating two mutually perpendicular polarized components. These two polarized components are reflected by the tracking galvano-mirror 48, relayed by the relay lenses 50 and 52, reflected by the follow-up galvano-mirror 54, and focused onto the recording disk 60 by the objective lens 56.

Since the reproducing reference light is made incident on the interference pattern recorded on the recording disk 60, reproducing information light corresponding to the information light generated during recording is generated, and enters the PBS 20 via the objective lens 56, the follow-up galvano-mirror 54, the relay lenses 52 and 50, the tracking galvano-mirror 48 and the optical rotary plate 46. Part of the reproducing reference light is reflected by the recording disk 60, and, similar to the reproducing information light, enters the PBS 20 via the objective lens 56, the follow-up galvano-mirror 54, the relay lenses 52 and 50, the tracking galvano-mirror 48 and the optical rotary plate 46.

The reproducing information light enters the PBS 20 to be S-polarized light by being transmitted through the optical rotary plate 46. On the other hand, returned light of the reproducing reference light is demodulated into P-polarized light by the optical rotary plate 46 and enters the PBS 20. The PBS 20 supplies the reproducing information light to the half mirror 16 and the returned light of the reproducing reference light to the half mirror 18. In other words, the reproducing information light and the reproducing reference light are separated from each other. The reproducing information light transmitted through the PBS 20 enters the half mirror 16, and half of the reproducing information light is transmitted through the half mirror 16 and is made to enter the image sensor 38 by the condenser lens 36. An image of the interference pattern recorded on the recording disk 60 is formed on the image pickup surface of the image sensor 38 by the condenser lens 36. The image sensor 38 converts into an electrical signal the reproducing information light that has recorded information two-dimensionally in a light-beam cross section. Each pixel of an image signal outputted from the image sensor 38 represents recorded information.

By using the optical rotary plate 46 divided into the right optical rotary plate 46R and the left optical rotary plate 46L, it is possible to prevent the reproducing reference light from entering the image sensor 38, i.e., it is possible to reproduce information with high SNR.

During reproduction as well, similarly to the case of recording, the control device 72 may also control the follow-up galvano-mirror 54 to move the reproducing reference light on the recording disk 60 instantaneously in the direction tangential to the track of the recording disk 60. Accordingly, the optical power of the reproducing reference light can be reduced, and the CNR (code/noise ratio) of the reproducing information light can be improved.

FIG. 4 is a timing chart showing the control operation of the follow-up galvano-mirror 54 during recording. The horizontal axis represents time, while the vertical axis represents displacement d occurring in the direction tangential to the track. This example shows the case where the recording disk 60 is rotated at 100 rpm. In hologram recording, information is intermittently recorded on the recording disk 60. Since a large amount of information can be contained in one spot, a large amount of information can be recorded and reproduced even if information is not continuously recorded. Accordingly, since the follow-up operation of the follow-up galvano-mirror 54 becomes intermittent, the return operation of returning a beam position which was moved during the previous follow-up operation needs to be performed in preparation for the next follow-up operation. In the example shown in FIG. 4, the speed of each follow-up operation is 418.7 mm/sec. The duration of each follow-up operation is 16μ seconds, and the period thereof is 437μ seconds (about 2.3 kHz). These numerical values can be satisfactorily realized with a galvano-mirror.

In a structure which moves an objective lens itself laterally in the direction of a track on a recording disk, its structure resonance frequency is 17 kHz, whereas the structure resonance frequency of the galvano-mirror is near 80 kHz at which high-speed response can be realized.

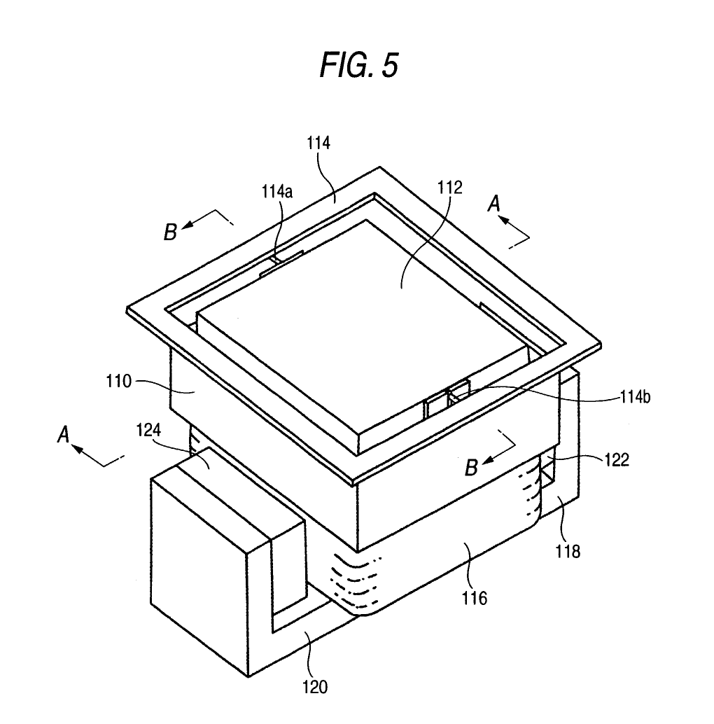

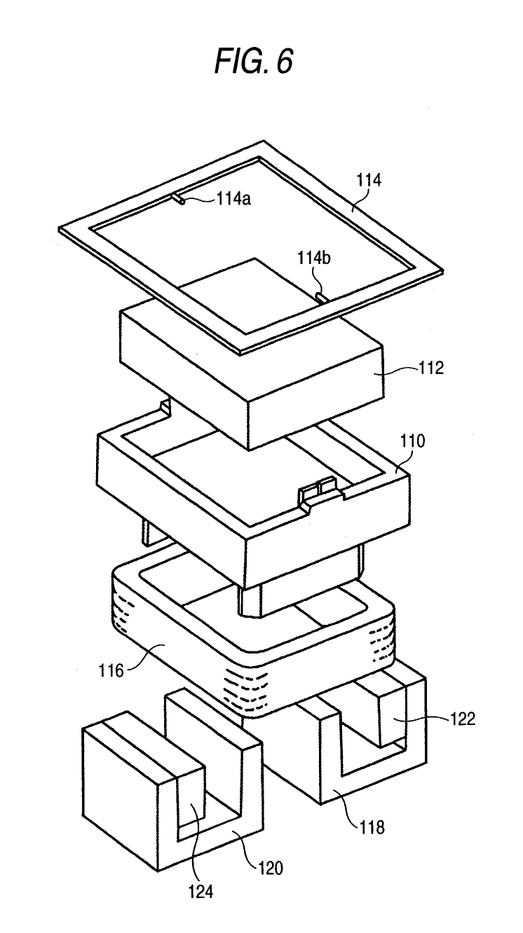

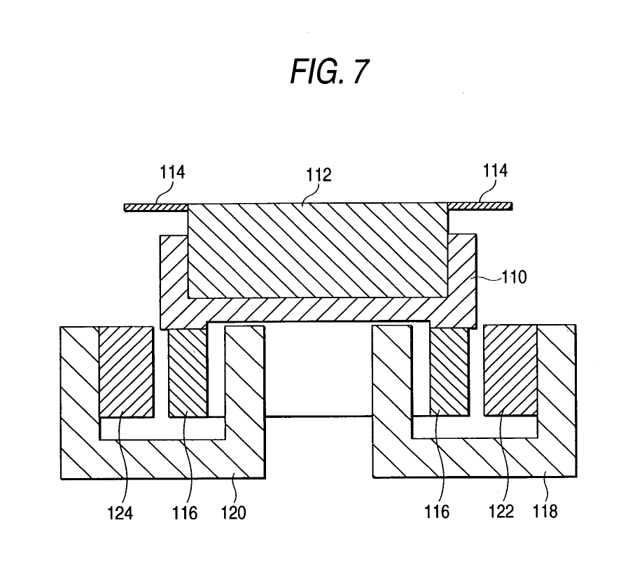

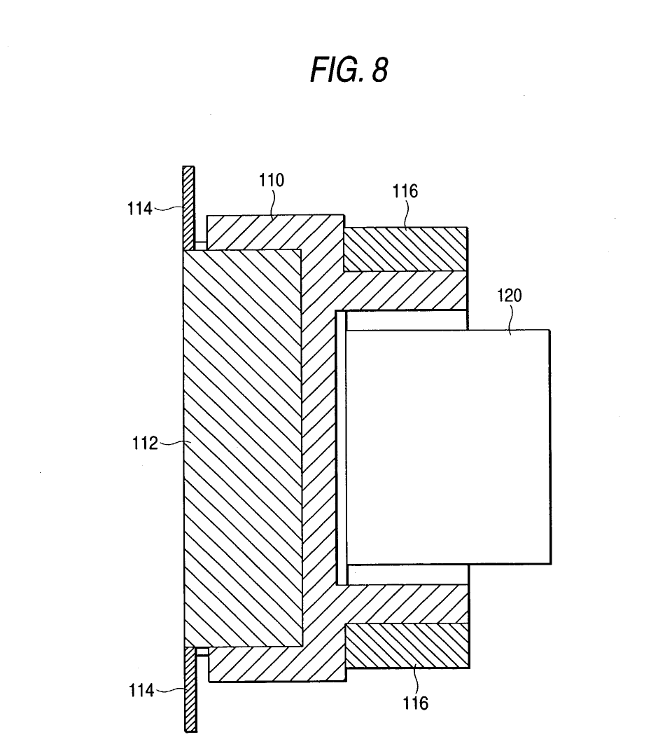

FIG. 5 is a perspective view showing either of the galvano-mirrors 48 and 54, and FIG. 6 is an exploded perspective view of the galvano-mirror 48 or 54 shown in FIG. 5. FIG. 7 is a cross-sectional view taken along line A-A of FIG. 5, and FIG. 8 is a cross-sectional view taken along line B-B of FIG. 5.

A mirror 112 is fixed to a holder 110. The holder 110 is rotatably supported by pins 114a and 114b of a leaf spring 114. The leaf spring 114 itself is fixed to a support portion (not shown) of the case 12. A coil 116 is fixed to the bottom of the holder 110. Yokes 118 and 120 are disposed at two opposite positions across the coil 116, and magnets 122 and 124 are respectively fixed to the yokes 118 and 120.

When electric current is made to flow through the coil 116, the mirror 112 is rotated about the pins 114a and 114b against the leaf spring 114. The rotating direction and the rotating speed of the mirror 112 can be controlled by adjusting the magnitude and the polarity of electric current flowing through the coil 116.

In this example, a mechanism for making a recording beam to follow up each individual track is provided as a mechanism separate from a focusing mechanism and a tracking mechanism, whereby a sufficient follow-up speed can be realized.

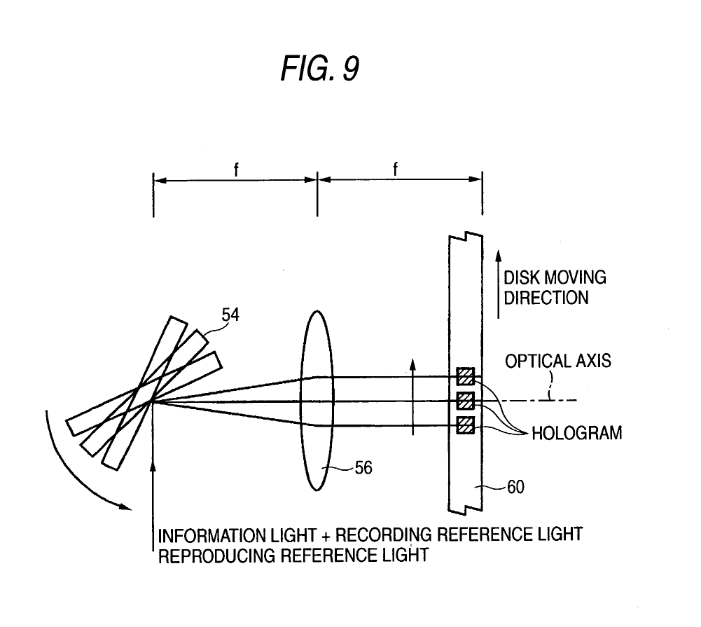

As shown in FIG. 9, in the case where the center of rotation of the follow-up galvano-mirror 54 is placed at the rear focus position of the objective lens 56 and the follow-up galvano-mirror 54 is rotated in synchronism with the rotation of the recording disk 60, the laser beam (information light and recording reference light during recording or reproducing reference light during reproduction) scanned by the follow-up galvano-mirror 54 follows up the movement of a target track of the recording disk 60. Accordingly, during recording, since the power of recording light becomes large, the output power of a light source can be reduced. During reproduction, since the image pickup time of reproducing light becomes long, SNR is improved. By oscillating the follow-up galvano-mirror 54 at the rear focus position (entrance pupil) of the objective lens 56, it is possible to realize a so-called telecentric optical system which causes light incident on the recording disk 60 to make parallel displacement. Accordingly, it is possible to realize stable recording and reproduction irrespective of the position of the beam being scanned.

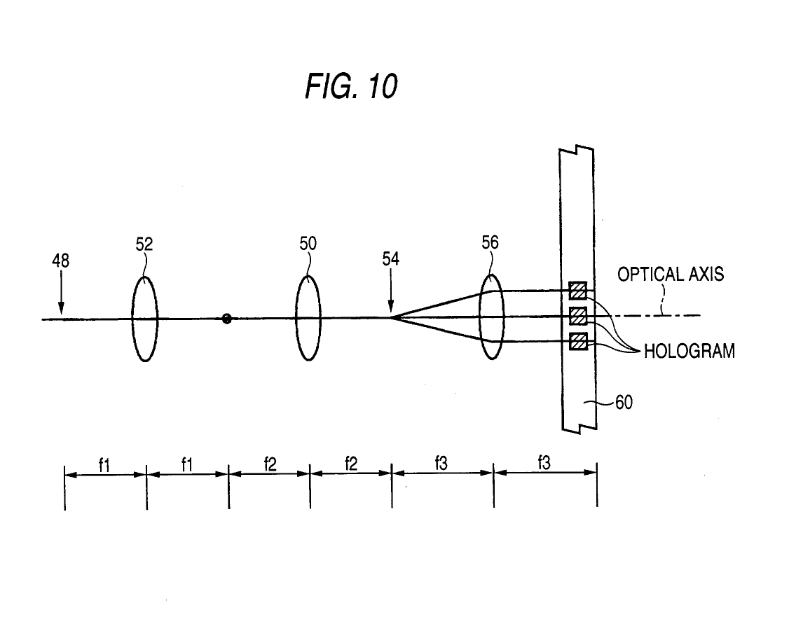

As shown in FIG. 10, in the case where the tracking galvano-mirror 48 is placed at the rear principal point of the relay lens 50 and the follow-up galvano-mirror 54 is placed at the front principal point of the relay lens 52, the galvano-mirrors 48 and 54 are respectively placed at conjugate positions. In FIG. 10, f1 denotes the focal length of the relay lens 50, f2 denotes the focal length of the relay lens 52, and f3 denotes the focal length of the objective lens 56. In the optical system shown in FIG. 10, by oscillating the tracking galvano-mirror 48 about the Z-axis, it is possible to cause the laser beam to make parallel displacement in the radial direction of the recording disk 60. Consequently, the laser beam can be moved at high speed in the radial and circumferential directions of the recording disk 60 by the galvano-mirrors 48 and 54.

In this example, since a focusing lens actuator for driving an objective lens for the purpose of focusing is provided separately from a track follow-up actuator, the mass of the objective lens may be selected to take account of only the follow-up characteristics of the focusing lens actuator, whereby a large (heavy) objective lens can be used. In other words, it is possible to increase the aperture of the objective lens and it is also possible to increase the amount of information to be recorded, whereby it is very advantageously possible to achieve high density and high transfer rate.

The track follow-up galvano-mirror 54 can be controlled in a frequency band of as high as 20-30 kHz. Accordingly, it is possible to achieve a great reduction in the amount of laser light to be outputted as well as a high transfer rate.

The galvano-mirror 48 may also be used for track follow-up, and the galvano-mirror 54 may also be used for tracking. However, in this case, the oscillation axis of each of the galvano-mirrors 48 and 54 needs to be modified.

As can be readily understood from the foregoing description, according to the invention, it is possible to realize a track follow-up mechanism of high-speed response which causes information light and reproducing reference light to follow up the movement of a track of a recording medium in a direction tangential to the track. Accordingly, it is possible to substantially reduce the output power of a light source.

It is intended that the appended claims be interpreted as including the embodiments described herein, the alternatives mentioned above, and all equivalents thereto.

What is claimed is:

1. An optical pickup device comprising:
a main optical system having a laser light source;
an electrically driven first beam deflector for deflecting laser light outputted from the main optical system;
an electrically driven second beam deflector for deflecting laser light deflected by the first beam deflector;
an objective lens for focusing output light of the second beam deflector on a disk-shaped recording medium; and
an objective lens driving device for driving the objective lens in opposite directions toward and away from the disk-shaped recording medium,
one of the first and second beam deflectors deflecting the laser beam to cause the laser beam to move on a recording layer of the disk-shaped recording medium in a radial direction of the disk-shaped recording medium,
the other of the first and second beam deflectors deflecting the laser beam to cause the laser beam to move on the recording layer of the disk-shaped recording medium in a circumferential direction of the disk-shaped recording medium.

2. An optical pickup device according to claim 1, wherein the main optical system is made of an interference optical system.

3. An optical pickup device according to claim 1, wherein each of the first and second beam deflectors is made of a galvano-mirror.

4. An optical pickup device according to claim 1 further comprising a relay optical system disposed between the first beam deflector and the second beam deflector and constructed to transfer the output light of the first beam deflector to the second beam deflector.

5. An optical pickup device according to claim 4, wherein the first beam deflector is disposed at an object-side principal point of the relay optical system and the second beam deflector is disposed at an image-side principal point of the relay optical system.

6. An optical pickup device according to claim 1, wherein the main optical system includes an image sensor for converting reproducing light reproduced from the disk-shaped recording medium into an electrical signal.
